(19) United States
(12) Patent Application Publication
(10) Pub. No.: US 2014/0086721 A1
(43) Pub. Date: Mar. 27, 2014

(54) Apparatus and method for unloading granular material from vehicles having one or more dump gates

(71) Applicants: Jay R. Wehrle, Fort Wayne, IN (US); Timothy J. Gerardot, Peru, IN (US)

(72) Inventors: Jay R. Wehrle, Fort Wayne, IN (US); Timothy J. Gerardot, Peru, IN (US)

(73) Assignee: Novae Corporation

(21) Appl. No.: 13/573,540

(22) Filed: Sep. 21, 2012

(51) Int. Cl. B65G 67/24

(52) U.S. Cl. 414/809

(57) ABSTRACT

A method and apparatus for unloading granular material from a vehicle having multiple dump gates and conveying the material to a desired height and location. The apparatus includes a hopper pivotally secured to a first inclined auger about a first vertical axis and pivotable to in-use and retracted positions. The first auger is pivotally secured to an inclined second auger about a second vertical axis. For unloading, the vehicle is placed adjacent the apparatus and, with the hopper retracted, the first auger is pivoted about the second axis closer to and under the vehicle. The hopper is then placed in the in-use position and receives grain from the first gate. The first auger is then pivoted placing the hopper under and receiving grain from the second gate. The hopper is then placed in the retracted position and the first auger is pivoted away from under the vehicle.

### BACKGROUND OF THE INVENTION

1. Field of the Invention

The present invention relates to the field of granular material augers and, more particularly, grain augers for lifting grain, corn, wheat, etc., into a silo or other storage container. Yet more particularly, the present invention is directed to a method and apparatus for easily and efficiently unloading grain trucks having one or more dump gates and conveying and lifting the granular material to a desired height and location.

2. Background

Granular material augers, also known as grain augers, are today widely used for lifting granular material such as wheat, corn, beans, grain, etc., to a desired height so as to place it into, for example, a storage silo or other storage container. Oftentimes, the granular material is simultaneously unloaded from a vehicle such as a grain truck or trailer onto a hopper that is connected to one or more augers which then convey and lift the grain up to the desired height and location.

Several such apparatus and methods have previously been devised for placing the hopper under the grain truck or trailer and then conveying the grain to the silo. The prior apparatus and methods, however, have shortcomings and drawbacks. An improved, relatively low cost, effective and easily useable method and apparatus for unloading granular material from vehicles having one or more dump gates, and for lifting and conveying the granular material to a desired height and location is needed and desired.

### SUMMARY OF THE INVENTION

In one form thereof, the present invention is directed to a method of unloading granular material from a vehicle by using a conveying auger apparatus, the vehicle having a plurality of dump gates where through the granular material may selectively flow towards a horizontal surface. The conveying auger apparatus includes: a hopper adapted to receive the granular material and to traverse along the horizontal surface; a first inclined conveying auger at an angle from the horizontal surface and having a first end and a second end, the hopper being pivotally secured to the first end of the first auger about a first vertical axis and wherein the hopper is pivotable to an in-use position whereat granular material received in the hopper may be conveyed by the apparatus and to a retracted position; and, a second inclined conveying auger at an angle from the horizontal surface and having a first end and a second end, the second end of the first auger being pivotally secured to the first end of the second auger about a second axis.

The method includes the steps of: locating the vehicle adjacent the conveying auger apparatus; with the hopper in its retracted position, pivoting the first inclined auger about the second axis and locating the hopper closer to the vehicle; pivoting the hopper about the first vertical axis and placing the hopper in its in-use position; placing the hopper under a first dump gate and receiving granular material therefrom in the hopper; pivoting the first inclined auger about the second axis and placing the hopper under a second dump gate and receiving granular material therefrom in the hopper; pivoting the hopper about the first vertical axis and placing the hopper in its retracted position; and, with the hopper in its retracted position, pivoting the first inclined auger about the second axis away from the vehicle.

Preferably, during the steps of receiving granular material in the hopper, the method includes conveying the granular material from the hopper through the first and second conveying augers and out through the second end of the second auger at a desired height above the horizontal surface. The conveying auger apparatus preferably includes a hydraulic cylinder pivotally secured at one end to the hopper and pivotally secured at its other end to the first inclined auger and the method further includes actuating the hydraulic cylinder for thereby pivoting the hopper about the first vertical axis during the steps of pivoting the hopper.

Yet more preferably, the conveying auger apparatus includes a linkage mechanism including a first link pivotally secured to a second link about vertical linkage axis, the first link also being pivotally secured to the first inclined auger and the second link also being pivotally secured to the hopper, the conveying auger apparatus further including a hydraulic cylinder pivotally secured at one end to the hopper and pivotally secured at its other end to the linkage mechanism, and the method further includes actuating the hydraulic cylinder for thereby pivoting the hopper about the first vertical axis during the steps of pivoting the hopper. The hydraulic cylinder can be pivotally secured to one or both of the first and second links of the linkage mechanism.

The conveying auger apparatus hopper can include an auger leading to an outlet port and the outlet port is pivotally secured to the first inclined auger. The first vertical axis is preferably located outside of the inclined auger and outside of the outlet port, the hopper auger includes a helical shaft having a terminal end and the first inclined auger includes a helical shaft having a terminal end, wherein the terminal ends are coupled to one another when the hopper is pivoted to its in-use position and said terminal ends are uncoupled from one another when the hopper is pivoted to its retracted position.

During the step of pivoting the hopper about the first vertical axis and placing the hopper in its in-use position, the hopper is preferably aligned with the first inclined auger and extends to a maximum length from the second axis, and during said step of pivoting the hopper about the first vertical axis and placing the hopper in its retracted position, the hopper is placed generally along a side of the first inclined auger.

The conveying auger apparatus preferably includes a selectively driven support wheel secured to and in part supporting the first inclined auger on the horizontal surface, and wherein the wheel is selectively driven during the steps of pivoting the first inclined auger about the second axis. During the steps of pivoting the hopper about the first vertical axis, the hopper can be pivoted up to 180°. The conveying auger apparatus includes in each of the hopper, the first inclined auger and the second inclined auger, helical shafts coupled to one another and being rotatably driven by a common power source.

In another form thereof, the present invention is directed to a conveying auger apparatus for transporting granular material to a desired height above a horizontal surface. The apparatus includes a hopper adapted to receive granular material and to traverse along the horizontal surface; a first inclined conveying auger at an angle from the horizontal surface and having a first end and a second end, the hopper being pivotally secured to the first end of the first auger about a first vertical axis; and, a second inclined conveying auger at an angle from the horizontal surface and having a first end and a second end, the second end of the first auger being pivotally secured to said first end of the second auger about a second vertical axis. The hopper is thereby selectively moveable along the horizontal surface by pivoting said hopper about the first vertical axis and the first inclined auger about the second vertical axis for placing under a stream of granular material, and granular material received in the hopper may be conveyed therefrom through the first and second conveying augers and out through the second end of the second auger at a desired height above the horizontal surface.

Preferably, the first vertical axis is located outside of the first inclined auger. A selectively driven support wheel is secured to and in part supports the first inclined auger, whereby the first inclined auger is selectively pivotable about the second vertical axis by selectively driving the wheel. Each of the hopper, the first inclined auger and the second inclined auger include a helical shaft coupled to one another and are rotatably driven by a common power source.

Yet more preferably, a linkage mechanism is provided including a first link pivotally secured to a second link about vertical linkage axis. The first link is also pivotally secured to the first inclined auger and the second link is also pivotally secured to the hopper. A hydraulic cylinder is pivotally secured at one end to the hopper and pivotally secured at its other end to the linkage mechanism whereby the hopper is selectively pivotable about the first vertical axis by actuating the hydraulic cylinder. The hydraulic cylinder is pivotally secured to one or both of the first and second links of the linkage mechanism.

The hopper auger preferably includes a helical shaft having a terminal end and the first inclined auger includes a helical shaft having a terminal end, wherein the terminal ends are coupled to one another when the hopper is pivoted placing the hopper helical shaft in alignment with the first inclined auger helical shaft and the terminal ends are uncoupled from one another when the hopper is pivoted placing the hopper helical shaft out of alignment with the first inclined auger helical shaft.

### BRIEF DESCRIPTION OF THE DRAWINGS

The above mentioned and other features of this invention, and the manner of attaining them, will become more apparent and the invention itself will be better understood by reference to the following description of the embodiments of the invention taken in conjunction with the accompanying drawings, wherein:

FIG. 1 is a perspective view of a conveying auger apparatus constructed in accordance with the principles of the present invention and shown in use powered by a tractor and located for conveying and lifting granular material to a silo opening;

FIG. 2 is a partial view of the conveying auger apparatus shown in FIG. 1 and showing in side elevation the hopper and first inclined auger;

FIG. 3 is a top plan view of the conveying auger apparatus as shown in FIG. 2 and showing the hopper in its in-use position aligned with the inclined auger and extending to a maximum length from the second inclined auger;

FIG. 4 is a cutaway top plan view of the apparatus similar to FIG. 3 illustrating the helical shafts therein;

FIG. 5 is a cutaway top plan view similar to FIG. 4 but depicting the hopper pivoted about the first vertical axis at an angle from the first inclined auger;

FIG. 6 is a top plan view of the hopper to first inclined auger pivotal connection shown in FIG. 5;

FIG. 7 is a perspective view of the hopper to first inclined auger pivotal connection shown in FIG. 6;

FIG. 7A is a perspective view similar to FIG. 6 but showing an alternate preferred embodiment of the pivotal connection;

FIG. 8 is a side elevation view of the conveying auger apparatus shown in FIG. 1 adjacent a vehicle carrying granular material;

FIG. 9 is a top plan view of the conveying auger apparatus and vehicle shown in FIG. 8 with the hopper in its retracted position along a side of the inclined auger;

FIG. 10 is a top plan view similar to FIG. 9 showing the first auger after having been pivoted closer toward the vehicle with the hopper in its retracted position;

FIG. 11 is a top plan view similar to FIG. 10 showing the hopper pivoted in its in-use maximum length position and placed under a first dump gate;

FIG. 12 is a top plan view similar to FIG. 11 showing the hopper and first auger after having been pivoted about the second pivot axis and the hopper placed under a second dump gate; and,

FIG. 13 is a top plan view similar to FIG. 12 after the hopper has been pivoted to its retracted position and after having pivoted the inclined first auger away from the vehicle.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

A conveying auger apparatus constructed in accordance with the principles of the present invention is shown and generally depicted in the drawings by the numeral 10. Conveying auger apparatus 10 is coupled to and is powered by a tractor 12 using a power takeoff (PTO) shaft 14 in a known and customary manner. Conveying auger apparatus 10, as more fully described hereinbelow, is adapted to relatively easily locate the hopper 16 thereof along the ground/horizontal surface 30 under one or more dump gates 18, 20 of a vehicle 22, and convey and lift granular material such as corn, wheat, grain, etc., from the hopper 16, through the first inclined auger 24 and the second inclined auger 26 to a desired height 28 above the ground 30 for pouring into and storing the granular material in a silo 32.

Conveying auger apparatus 10 is further adapted to be attached to and towed by the tractor 12 in a known and customary manner. The second inclined auger 26 includes lifting means 34 and wheels 36 for towing the apparatus 10 to a desired location and lifting the second auger 26 to a desired angle and height 28. Structural cable means 38 are also provided on the second auger 26 for stabilizing over the length thereof.

Hopper 16 is supported on the ground/horizontal surface 30 and is adapted to traverse thereon with caster wheels 40. Hopper 16 includes a pan 42 having an opening 44 facing vertically upwardly wherethrough the granular material is received. Handles 46 may be provided on the pan 42. Extension walls may also be provided above the opening 44 for better catching and directing granular material into the opening 44. A grate 48 is provided over the opening 44 for preventing undesirable large items from entering the pan 42 and to guard the helical augers shafts 50 therein.

The helical auger shafts 50 extend longitudinally in the pan and are coupled to and rotatably driven therein through a gear box 52. An outlet helical auger shaft 54 is coupled to the gearbox 52 and extends to an outlet tube and port 56. Hence, by rotatably driving the outlet auger shaft 54, the hopper auger shafts 50 are simultaneously rotatably driven through the gear box 52, and granular material received through the opening 44 into the pan 42 is conveyed toward and through the hopper outlet tube/port 56.

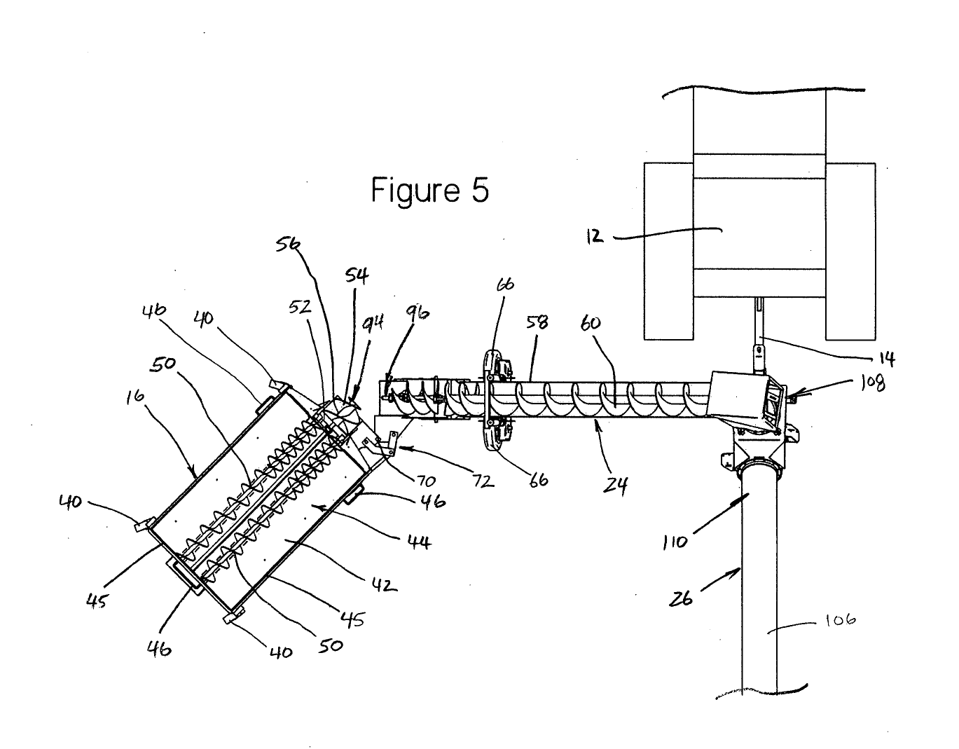

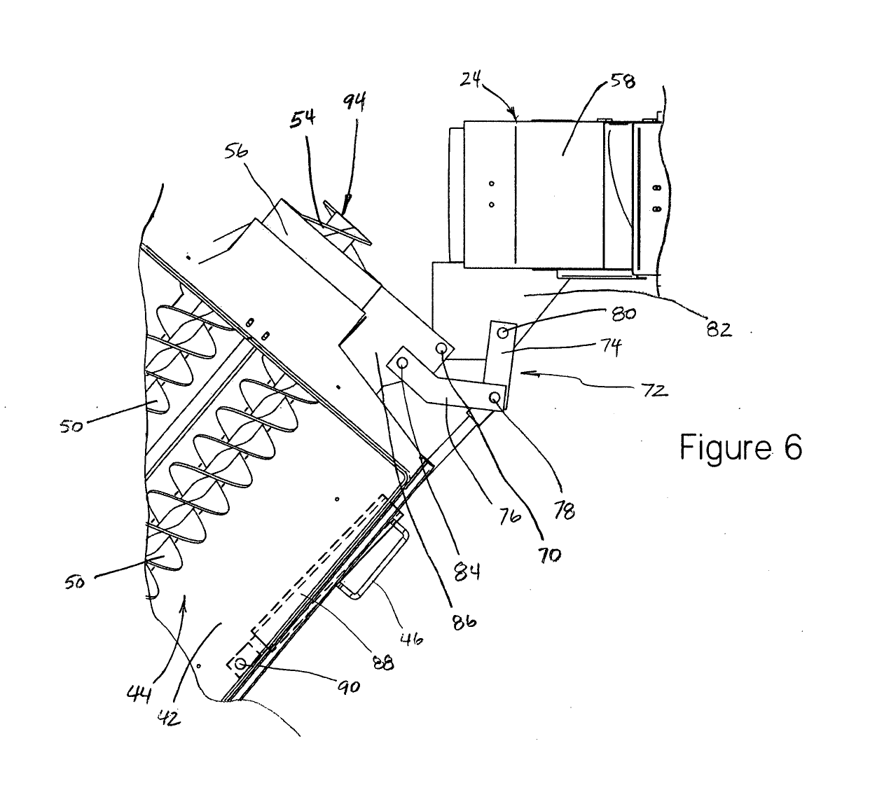

The first inclined auger 24 includes an outer tube 58 and a helical auger shaft 60 extending therein between a first end 62 and a second end 64. The hopper 16 is pivotally secured to the first end 62 of the first inclined auger 24 so at to pivot about a first vertical axis/fastener 70. Vertical axis 70 is outside of both the outlet tube/port 56 and the auger tube 58 so that, when the hopper 16 is pivoted away from the auger 24 toward its retracted position, the outlet port/tube “breaks away” from and is separated from the auger 24 as depicted in FIGS. 5 and 6.

To facilitate the pivoting of hopper 16 about pivot axis 70, a linkage mechanism 72 is provided including a first link 74 pivotally secured to a second link 76 about vertical linkage axis/fastener 78. The first link 74 is pivotally secured to the first inclined auger 24 with a fastener 80 and a plate 82 which is secured to the auger tube 58. The second link 76 is pivotally secured to the hopper 16 with a fastener 84 and a plate 86 which is secured to the hopper pan 42 and the outlet tube/port 56. The vertical axis/fastener is located on and pivotally secures plates 82, 86 to one another. It is noted that as, used herein, “vertical” means generally perpendicular to the ground/horizontal surface 30 so that, for example, as hopper 16 pivots about the vertical axis 70 relative to the first inclined auger 24, it remains on the ground/horizontal surface 30.

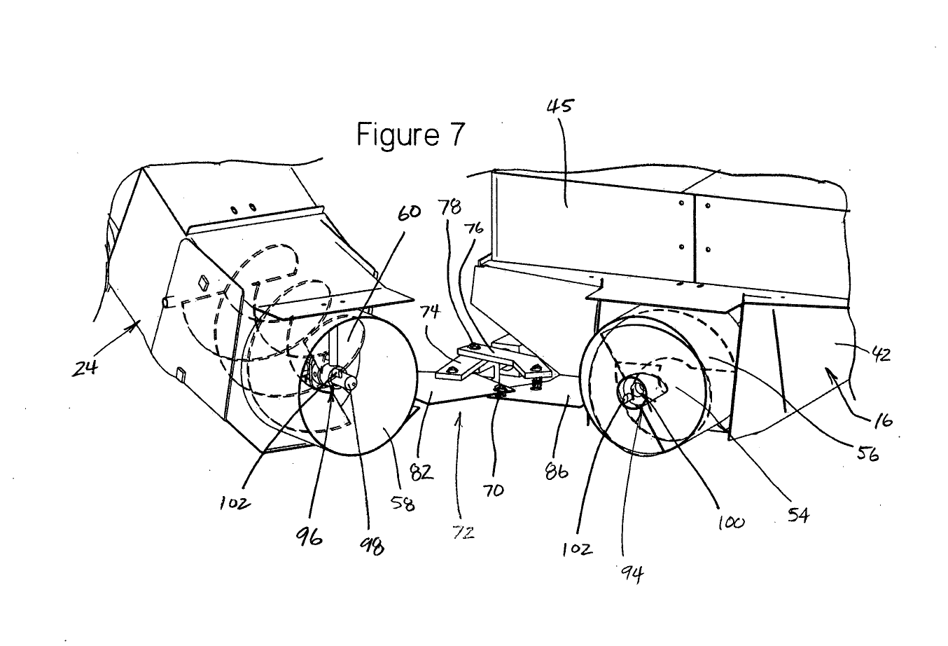

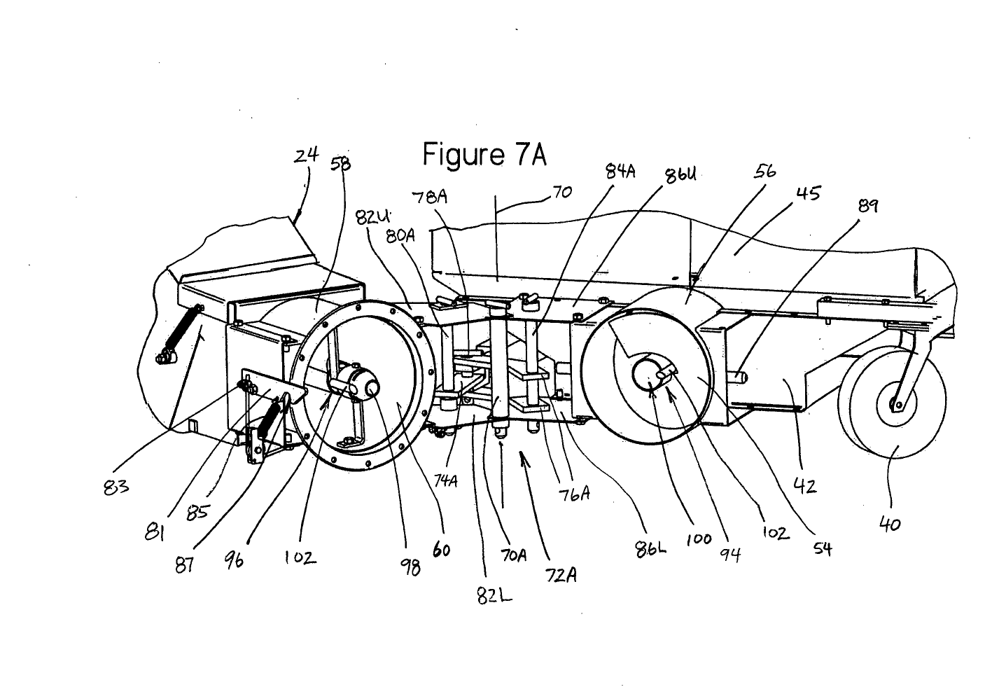

An alternate preferred linkage mechanism 72A is shown in FIG. 7A. In this embodiment, upper and lower plates 82U and 82L are located in parallel planes and are each secured to the auger tube 58. Upper and lower parallel plates 86U and 86L are each secured to the hopper pan 42 and the outlet tube/port 56. A pin 70A extends through holes in both the upper and lower plates 82U, 82L, 86U, 86L and forms the pivotal connection about the first pivotal axis 70 between the hopper 16 and the auger 24. A fastener pin 80A extends through holes in both the upper and lower plates 82U, 82L and through a hole in link 74A. Link 74A is thereby pivotally secured to plates 82U, 82L through fastener pin 80A. Similarly, a fastener pin 84A extends through holes in both the upper and lower plates 86U, 86L and through a hole in a pair of links 76A. Links 76A are thereby pivotally secured to plates 86U, 86L through fastener pin 84A. Link 74A, links 76A and the hydraulic cylinder 88 are pivotally secured together with a fastener pin 78A. As should be appreciated, the pivotal connection between hopper 16 and auger 24 and the linkage mechanism 72A of the preferred embodiment of FIG. 7A is structurally stronger and more durable.

As also shown in FIG. 7A, a locking arm 81 is pivotally secured to the first inclined auger 24 with a faster screw 83. An extension spring 85 is connected between the terminal end of arm 81 and the auger 24. Arm 81 is provided with a notch 87 adapted to receive a pin 89 which is secured to the outlet tube 57 of hopper 16. Accordingly, when tube 56 of hopper 16 and tube 58 of auger 24 are aligned, pin 89 is received in the notch 87 of arm 81 for thereby securely locking the tubes 56, 58 to one another. When placing the hopper in its retracted position, the arm is lifted against the bias of spring 85 releasing the pin 89 from notch 87 and thereby unlatching the hopper 16 from the auger 24.

A cleanout door 90 is provided on an opening through the auger tube 58. Cleanout door is maintained on the auger tube 24 over the opening with extension springs 91 located on both sides thereof. As can be appreciated, cleanout door 90 provides access to the inside of tube 58 for visual inspection and, if necessary, cleaning out the tube 58.

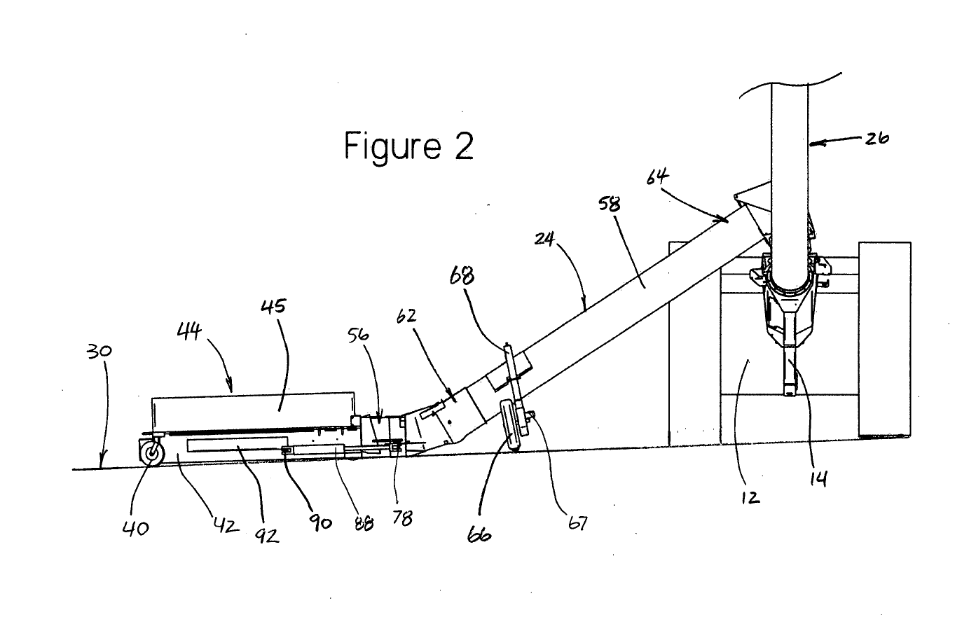

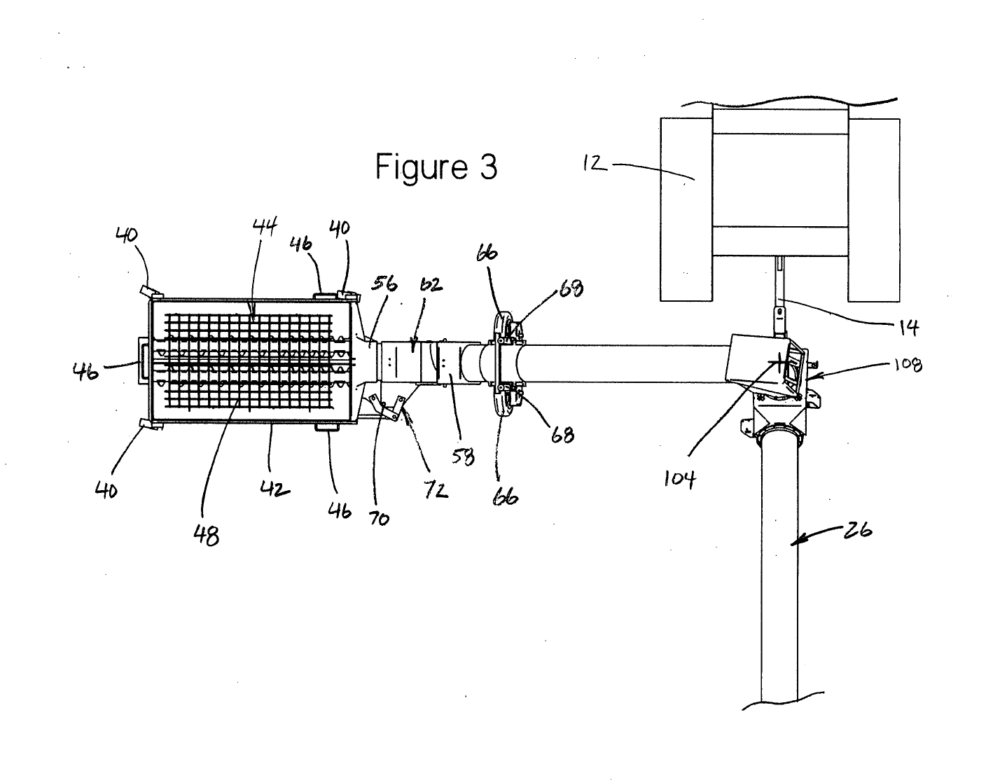

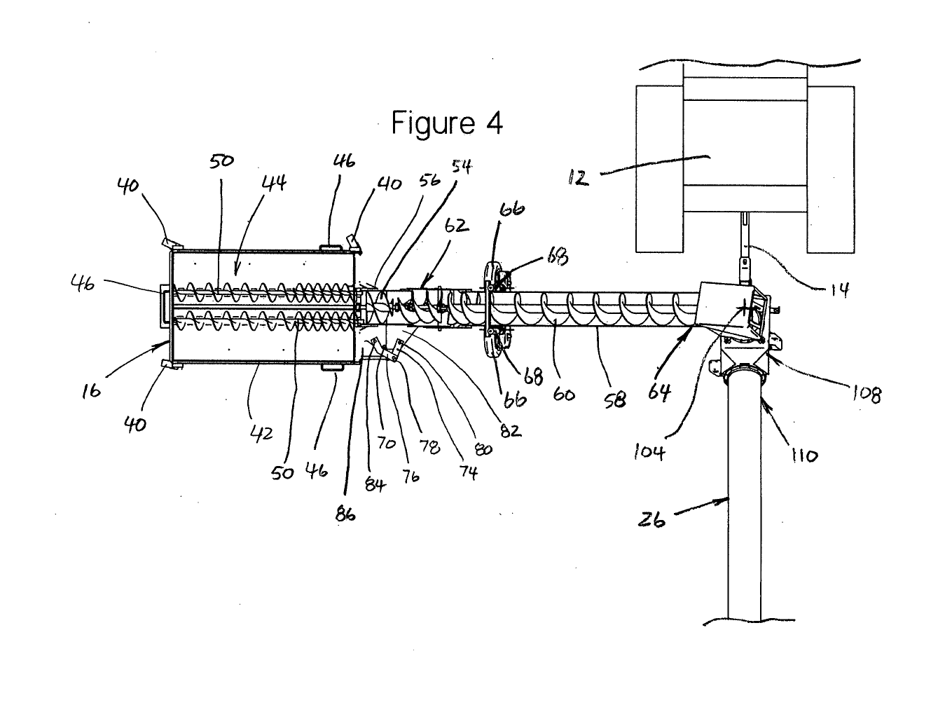

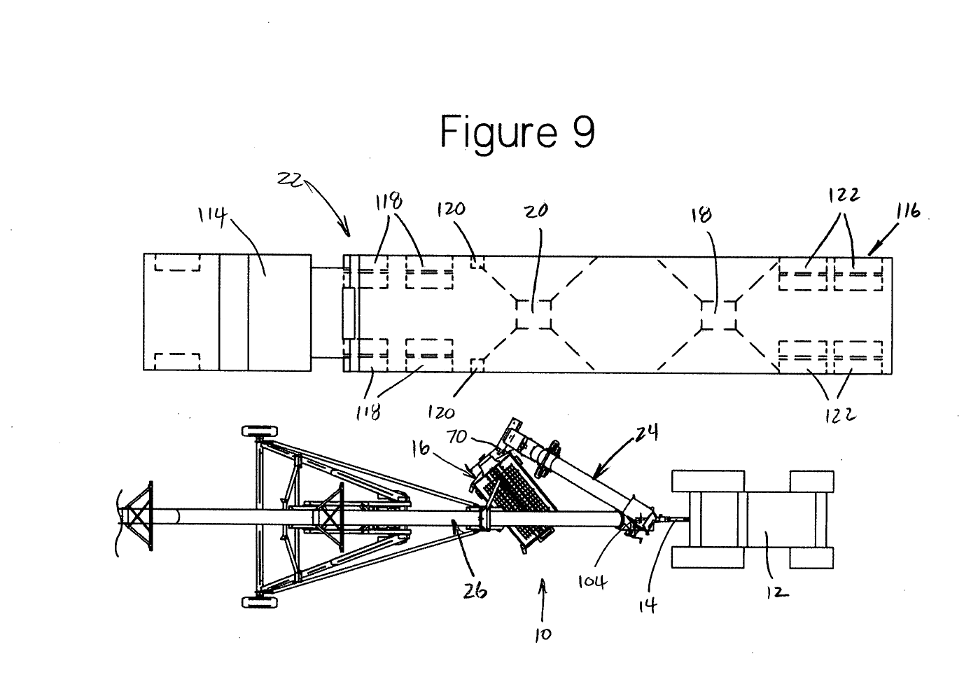

A hydraulic cylinder 88 is at one pivot end 90 pivotally secured to a structural angle 92 which is secured to the hopper 16. At its other end, hydraulic cylinder 88 is pivotally secured to the vertical linkage axis/fastener 78. Accordingly, by actuating the hydraulic cylinder 88, the hopper 16 is selectively pivotable about the vertical pivot axis 70 and can be pivoted to an in-use position whereat the hopper 16 is longitudinally aligned with the auger 24, and the outlet tube/port 56 is aligned with and forms a continuous tube with the auger tube 58 (FIGS. 2-4). By actuating the hydraulic cylinder 88 in the opposite direction, hopper 16 can also be pivoted toward its retracted position (FIG. 9) whereat the outlet tube/port 56 is separated from the auger tube 58 and the hopper is placed generally along the side of the auger 24, thereby minimizing its total longitudinal length. It is noted that the linkage mechanism 72 and hydraulic cylinder 88 can also be provided on the other side of the hopper 16 and auger tube 58 and/or they can be made detachably attachable for attachment on either side as needed or desired.

The terminal end 94 of hopper helical auger shaft 54 is adapted to be coupled to the terminal end 96 of helical auger shaft 60 when the hopper is in its in-use position, and to be uncoupled when in its retracted position. To this end, a centering cone is 98 provided on the terminal end 96 of shaft 60 and is received in a corresponding bore 100 on the terminal end 94 of the shaft 54. Drive lugs 102 on each of the terminal ends 94, 96 are adapted to engage one another and thereby rotatably attach the shafts 50, 60 to one another whereby, by rotatably driving shaft 60, shaft 54 is also rotably driven.

The second inclined auger 26 includes an outer tube 106 and a helical auger shaft (not shown) extending therein between a first end 110 and a second end 112. The second end 64 of the first inclined auger 24 is pivotally secured to the first end 110 of the second inclined auger 26 in a known and customary manner. The first inclined auger 24 is thereby adapted to pivot relative to the second inclined auger 26 about a second vertical axis 104.

Auger 24 is positioned at an incline/angle upwardly from the ground 30 and is in part supported on the ground by support wheels 66 mounted thereto with adjustable jacks 68. Wheels 66 can be connected to and selectively driven by a hydraulic motor 67. Accordingly, the first inclined auger 24 is pivotable about the second vertical axis 104 by selectively rotatably driving the wheels 66.

A gearbox 108 is provided whereby the tractor PTO is coupled to and rotably drives the helical shafts of both the first auger 24 and the second auger 26. Gearbox 108 is also adapted to convey/transfer, in a known and customary manner, granular material from the first auger 24 to the second auger 26. As should now be appreciated, the tractor PTO 14 is coupled to and rotatably drives all of the helical shafts of the apparatus 10 whereby granular material received in the hopper 16 may be conveyed therefrom through the first and second conveying augers 24, 26 and out through the second end 112 of the second auger 26 at a desired height 28 above the horizontal surface 30.

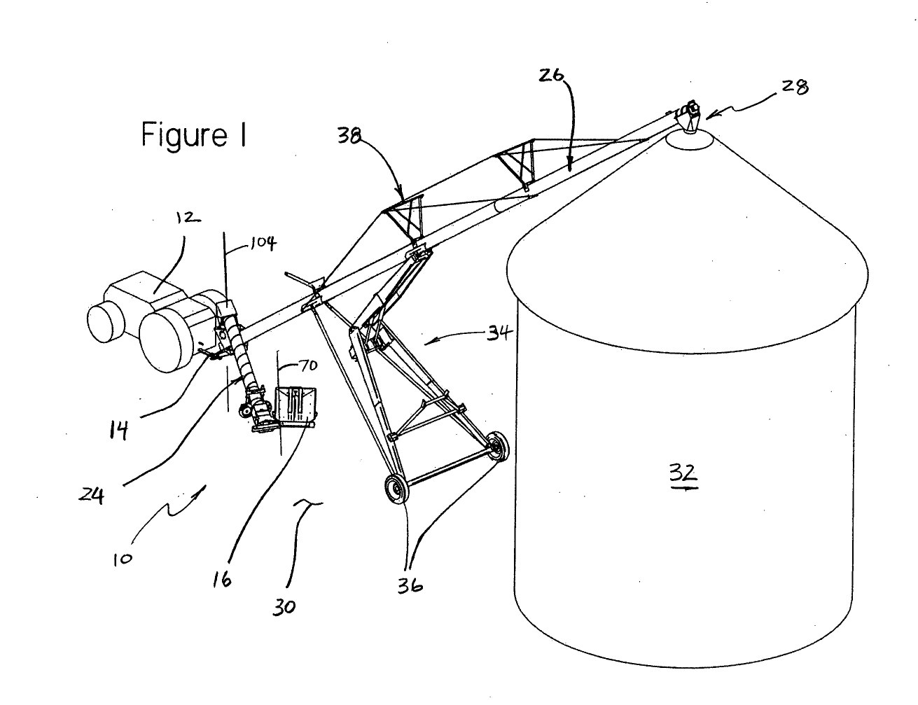

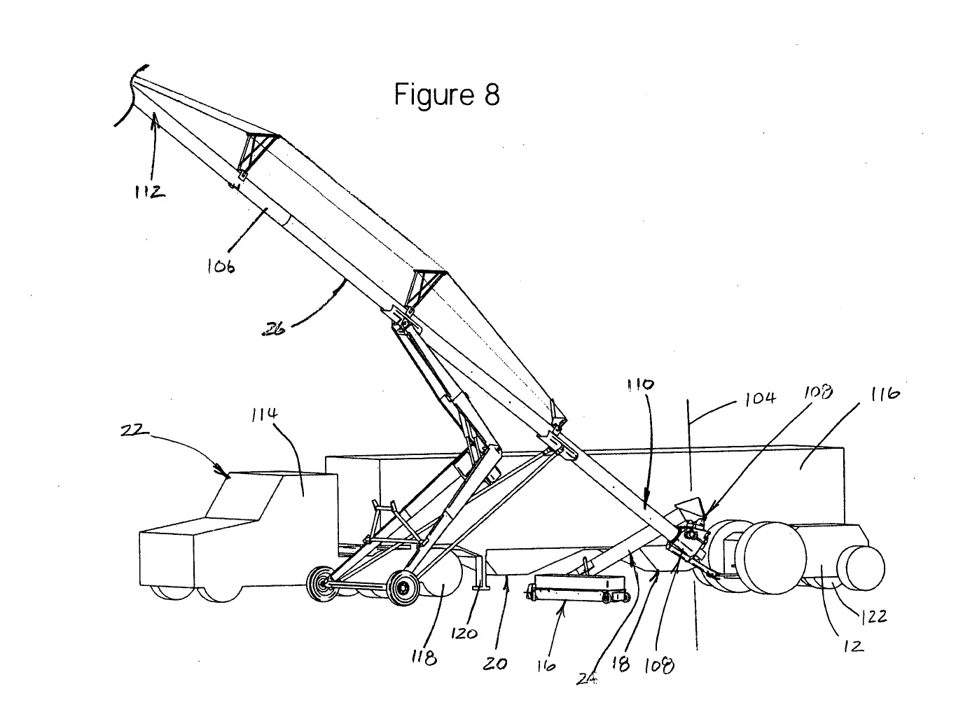

The operation and method of use of the conveying auger apparatus 10 will now be described by reference to FIGS. 1 and 8-13. At the outset, with the conveying augur apparatus 10 located as shown in FIG. 1, with the second end 112 of the second auger 26 at a desired height 28 and over an opening of a silo 32, a vehicle 22 is located adjacent the apparatus 10 as depicted in FIGS. 8-13. Vehicle 22 can be, as shown, a semi tractor 114 and grain trailer 116. Semi tractor includes rear wheels 118. Trailer 116 includes front landing gear 120 and rear wheels 122. As described hereinafter, the hopper 16 can now easily be located under the trailer 116 and the granular material therein unloaded from both the dump gates 18, 20 even though the distance between the landing gear 120 and the trailer rear wheels 122 is relatively short and without the need to move the trailer 116.

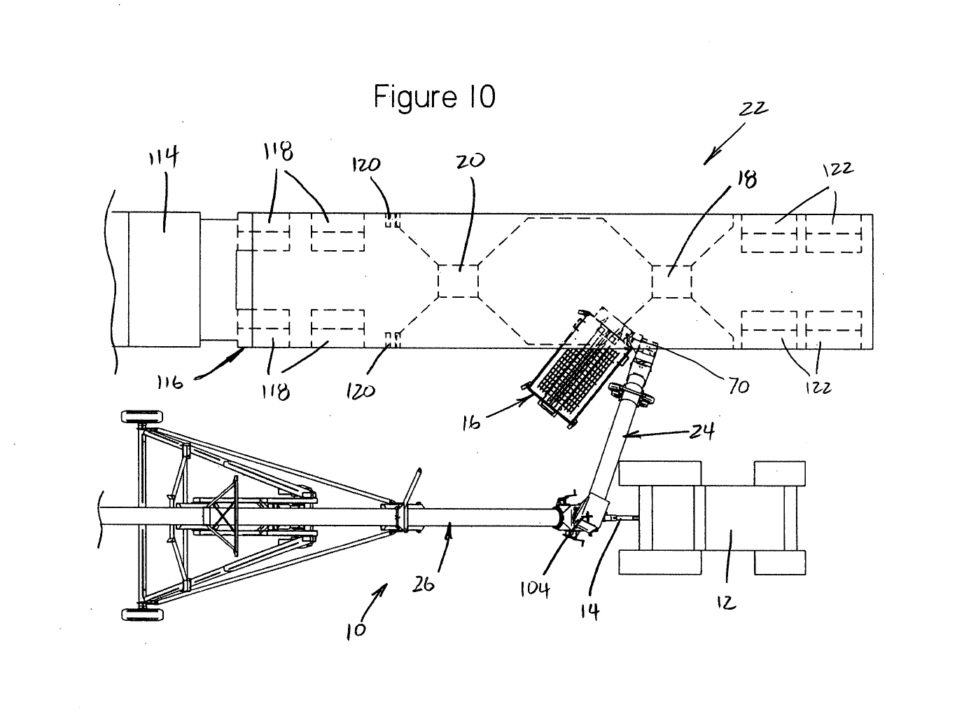

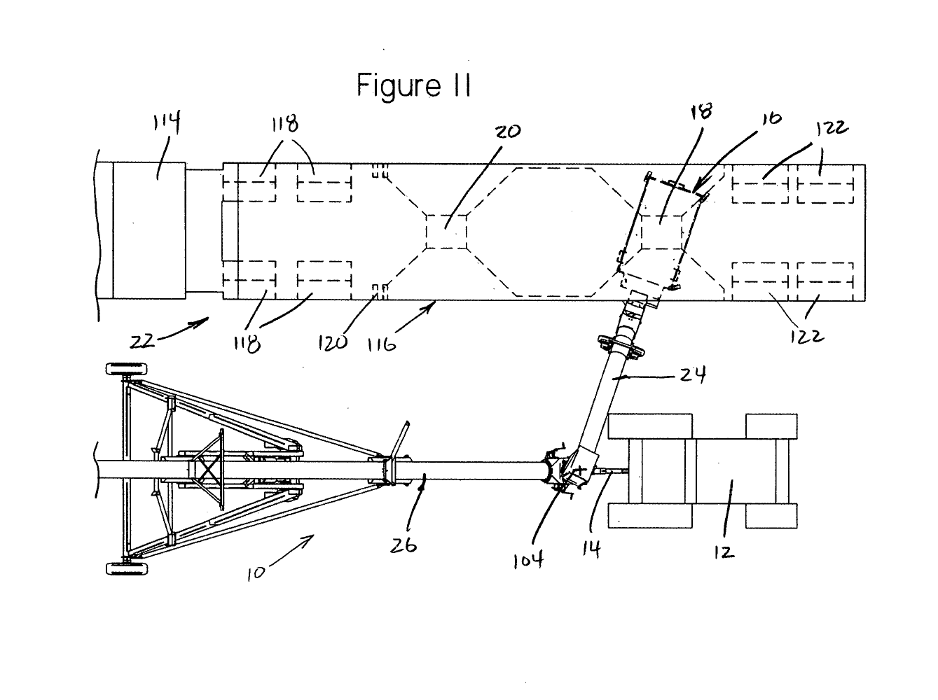

Starting with the hopper 16 in its retracted position as shown in FIG. 9, the first auger 24 is pivoted about the second axis 104, by preferably using the hydraulically driven wheels 66, to a position for locating the hopper 16 closer to the vehicle 22/trailer 116, for example, as shown in FIG. 10, to an area between the trailer rear wheels 122 and the landing gear 120. The hopper 16 is then pivoted about the vertical axis 70, preferably using the hydraulic cylinder 88, from the retracted position to the in-use maximum length position as shown in FIG. 11, and is placed under the dump gate 18. It is noted that the inclined auger 24 may be pivotally adjusted about the second axis 104 at this time, as may be needed, for centering the hopper 16 under the gate 18.

In the in-use position as shown in FIG. 11, the dump gate 18 is opened allowing the granular material to fall into the hopper 16 through the opening 44 thereof. The helical shafts of the apparatus 10 are rotatably driven as described hereinabove and the granular material is thereby conveyed from the hopper 16 through the first and second conveying augers 24, 26 and out through the second end 112 of the second auger 26 at the desired height 28 above the horizontal surface 30.

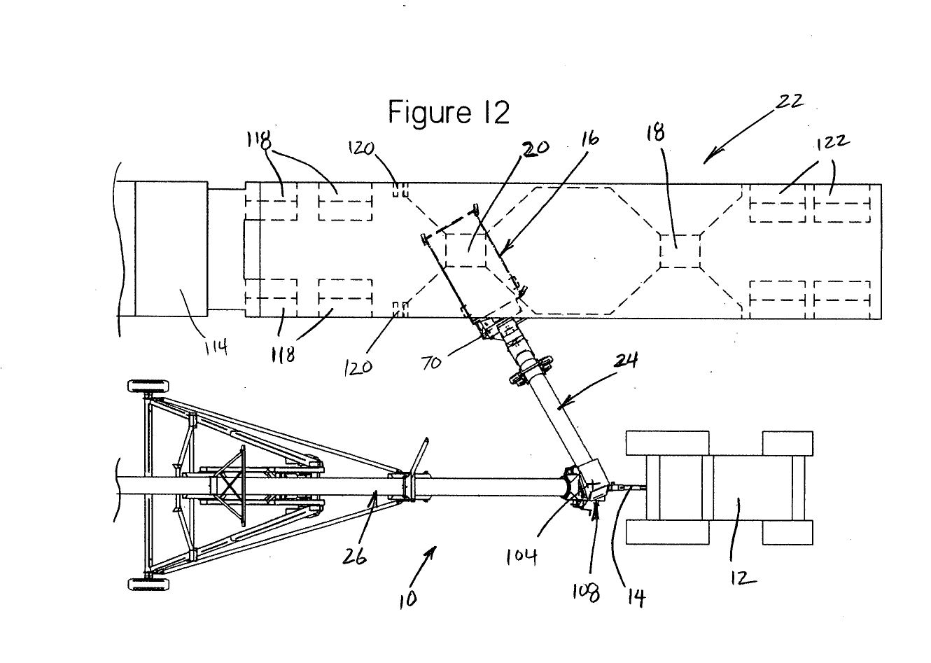

After depleting the granular material at the dump gate 18, the auger 24 is pivoted about the second vertical axis 104, again preferably using the hydraulically driven wheels 66, for thereby placing the hopper 16 under the other dump gate 20 as shown in FIG. 12. In this position, the dump gate 20 is opened allowing the granular material to fall into and similarly be received in the hopper 16. Again the helical shafts of the apparatus 10 are rotatably driven as described hereinabove and the granular material is thereby conveyed from the hopper 16 through the first and second conveying augers 24, 26 and out through the second end 112 of the second auger 26 at the desired height 28 above the horizontal surface 30.

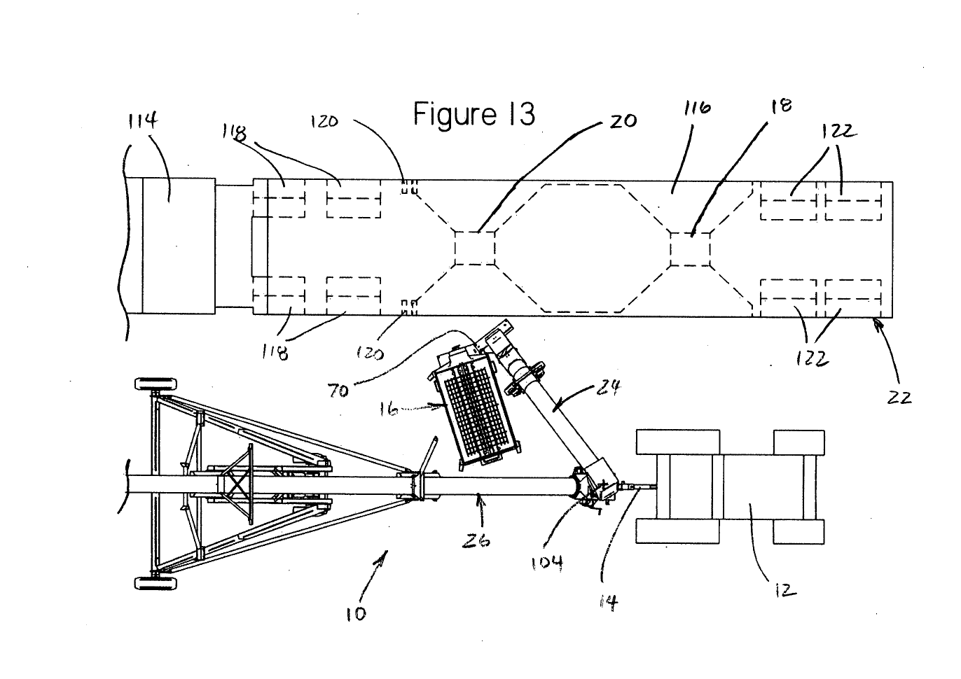

After depleting the granular material at the dump gate 20, the hopper 16 is pivoted about the first vertical axis 70 and placed in its retracted position, again preferably using the hydraulic cylinder 88. With the hopper 16 in its retracted position, the first auger 24 is then pivoted about the second axis 104 away from the vehicle 22/trailer 116 as shown in FIG. 13. In this position, the apparatus 10 is out of the travel path of the vehicle 22 and it can leave therefrom. The process can then be repeated with another or the same vehicle 22.

While this invention has been described as having an exemplary design, the present invention may be further modified within the spirit and scope of this disclosure. This application is therefore intended to cover any variations, uses, or adaptations of the invention using its general principles.

1. A method of unloading granular material from a vehicle by using a conveying auger apparatus, the vehicle having a plurality of dump gates where through the granular material may selectively flow towards a horizontal surface, the conveying auger apparatus including: a hopper adapted to receive the granular material and to traverse along the horizontal surface; a first inclined conveying auger at an angle from the horizontal surface and having a first end and a second end, the hopper being pivotally secured to the first end of the first auger about a first vertical axis and wherein the hopper is pivotable to an in-use position whereat granular material received in the hopper may be conveyed by the apparatus and to a retracted position; and, a second inclined conveying auger at an angle from the horizontal surface and having a first end and a second end, the second end of the first auger being pivotally secured to the first end of the second auger about a second axis; said method comprising the steps of:
locating the vehicle adjacent the conveying auger apparatus;
with the hopper in its retracted position, pivoting the first inclined auger about the second axis and locating the hopper closer to the vehicle;
pivoting the hopper about the first vertical axis and placing the hopper in its in-use position;
placing the hopper under a first dump gate and receiving granular material therefrom in the hopper;
pivoting the hopper about the first vertical axis and placing the hopper in its retracted position; and,
with the hopper in its retracted position, pivoting the first inclined auger about the second axis away from the vehicle.

2. The method of claim 1 further comprising, after the step of receiving granular material from the first dump gate in the hopper, pivoting the first inclined auger about the second axis and placing the hopper under a second dump gate and receiving granular material therefrom in the hopper and, during said steps of receiving granular material in the hopper, conveying the granular material from the hopper through the first and second conveying augers and out through the second end of the second auger at a desired height above the horizontal surface.

3. The method of claim 2 wherein the conveying auger apparatus includes a hydraulic cylinder pivotally secured at one end to the hopper and pivotally secured at its other end to the first inclined auger and further comprising actuating the hydraulic cylinder for thereby pivoting the hopper about the first vertical axis during said steps of pivoting the hopper.

4. The method of claim 2 wherein the conveying auger apparatus includes a linkage mechanism including a first link pivotally secured to a second link about vertical linkage axis, the first link also being pivotally secured to the first inclined auger and the second link also being pivotally secured to the hopper, the conveying auger apparatus further including a hydraulic cylinder pivotally secured at one end to the hopper and pivotally secured at its other end to the linkage mechanism, and further comprising actuating the hydraulic cylinder for thereby pivoting the hopper about the first vertical axis during said steps of pivoting the hopper.

5. The method of claim 4 wherein the hydraulic cylinder is pivotally secured to one or both of the first and second links of the linkage mechanism.

6. The method of claim 2 wherein the conveying auger apparatus first vertical axis is located outside of the first inclined auger.

7. The method of claim 2 wherein the conveying auger apparatus hopper includes an auger leading to an outlet port and the outlet port is pivotally secured to the first inclined auger.

8. The method of claim 7 wherein the conveying auger apparatus first vertical axis is located outside of the inclined auger and outside of the outlet port, and further wherein the hopper auger includes a helical shaft having a terminal end and the first inclined auger includes a helical shaft having a terminal end, wherein the terminal ends are coupled to one another when the hopper is pivoted to its in-use position and said terminal ends are uncoupled from one another when the hopper is pivoted to its retracted position.

9. The method of claim 8 wherein, during said step of pivoting the hopper about the first vertical axis and placing the hopper in its in-use position, the hopper is aligned with the first inclined auger and extends to a maximum length from the second axis, and during said step of pivoting the hopper about the first vertical axis and placing the hopper in its retracted position, the hopper is placed generally along a side of the first inclined auger.

10. The method of claim 9 wherein the conveying auger apparatus includes a selectively driven support wheel secured to and in part supporting the first inclined auger on the horizontal surface, and wherein the wheel is selectively driven during the steps of pivoting the first inclined auger about the second axis.

11. The method of claim 10 wherein the conveying auger apparatus includes a hydraulic cylinder pivotally secured at one end to the hopper and pivotally secured at its other end to the first inclined auger and further comprising actuating the hydraulic cylinder for thereby pivoting the hopper about the first vertical axis during said steps of pivoting the hopper.

12. The method of claim 1 wherein the conveying auger apparatus includes a hydraulic cylinder pivotally secured at one end to the hopper and pivotally secured at its other end to the first inclined auger and further comprising actuating the hydraulic cylinder for thereby pivoting the hopper about the first vertical axis during said steps of pivoting the hopper.

13. The method of claim 1 wherein the conveying auger apparatus includes a linkage mechanism including a first link pivotally secured to a second link about vertical linkage axis, the first link also being pivotally secured to the first inclined auger and the second link also being pivotally secured to the hopper, the conveying auger apparatus further including a hydraulic cylinder pivotally secured at one end to the hopper and pivotally secured at its other end to the linkage mechanism, and further comprising actuating the hydraulic cylinder for thereby pivoting the hopper about the first vertical axis during said steps of pivoting the hopper.

14. The method of claim 13 wherein the hydraulic cylinder is pivotally secured to one or both of the first and second links of the linkage mechanism.

15. The method of claim 1 wherein the conveying auger apparatus first vertical axis is located outside of the first inclined auger.

16. The method of claim 1 wherein during said steps of pivoting the hopper about the first vertical axis, the hopper is pivoted up to 180°.

17. The method of claim 1 wherein during said step of pivoting the hopper about the first vertical axis and placing the hopper in its in-use position, the hopper is aligned with the first inclined auger and extends to a maximum length from the second axis.

18. The method of claim 1 wherein during said step of pivoting the hopper about the first vertical axis and placing the hopper in its retracted position, the hopper is placed generally along a side of the first inclined auger.

19. The method of claim 1 wherein the conveying auger apparatus includes a selectively driven support wheel secured to and in part supporting the first inclined auger, and wherein the wheel is selectively driven during the steps of pivoting the first inclined auger about the second axis.

20. The method of claim 1 wherein the conveying auger apparatus includes in each of the hopper, the first inclined auger and the second inclined auger, helical shafts coupled to one another and being rotatably driven by a common power source.

21. The method of claim 1 wherein the conveying auger apparatus hopper includes an auger leading to an outlet port and the outlet port is pivotally secured to the first inclined auger.

22. The method of claim 21 wherein the conveying auger apparatus first vertical axis is located outside of the inclined auger and outside of the outlet port, and further wherein the hopper auger includes a helical shaft having a terminal end and the first inclined auger includes a helical shaft having a terminal end, wherein the terminal ends are coupled to one another when the hopper is pivoted to its in-use position and said terminal ends are uncoupled from one another when the hopper is pivoted to its retracted position.

23. The method of claim 22 wherein:
during said step of pivoting the hopper about the first vertical axis and placing the hopper in its in-use position, the hopper is aligned with the first inclined auger and extends to a maximum length from the second axis, and during said step of pivoting the hopper about the first vertical axis and placing the hopper in its retracted position, the hopper is placed generally along a side of the first inclined auger;
the conveying auger apparatus includes a selectively driven support wheel secured to and in part supporting the first inclined auger, and wherein the wheel is selectively driven during the steps of pivoting the first inclined auger about the second axis;
the second pivot axis between the first inclined auger and the second inclined auger is vertical; and,
the conveying auger apparatus includes a hydraulic cylinder pivotally secured at one end to the hopper and pivotally secured at its other end to the first inclined auger and further comprising actuating the hydraulic cylinder for thereby pivoting the hopper about the first vertical axis during said steps of pivoting the hopper.

24. The method of claim 23 wherein the conveying auger apparatus includes in each of the hopper, the first inclined auger and the second inclined auger, helical shafts coupled to one another and being rotatably driven by a common power source.

25. The method of claim 1 further comprising, after the step of receiving granular material from the first dump gate in the hopper, pivoting the first inclined auger about the second axis and placing the hopper under a second dump gate and receiving granular material therefrom in the hopper.

26-42. (canceled)
